(19) United States
(12) Patent Application Publication
(10) Pub. No.: US 2013/0062443 A1
(43) Pub. Date: Mar. 14, 2013

(54) METHOD OF DRY SEPARATION FOR CONCENTRATION AND SEPARATION AND A SYSTEM USED FOR THE METHOD OF DRY SEPARATION FOR CONCENTRATION AND SEPARATION

(71) Applicant: Zhongwu Wang, Beijing (CN)

(72) Inventor: Zhongwu Wang, Beijing (CN)

(21) Appl. No.: 13/384,325

(22) PCT Filed: Nov. 1, 2011
(86) PCT No.: PCT/CN11/81632

§ 371 Date: Jan. 16, 2012

(30) Foreign Application Priority Data
Apr. 11, 2011 (CN) 201110089725.9

(51) Int. Cl. B02C 23/08

(52) U.S. Cl. 241/24.1; 241/68

(57) ABSTRACT

This invention relates to a method of dry separation for concentration and separation and a system used for the method of dry separation for concentration and separation. In the method of dry separation for concentration and separation, ore is crushed by a crusher first, and after being dry ground, materials are concentrated in conditions of airflow ventilation and vibration of the directional second vibrator by way of a dry separation concentrator. The system includes a materials feeding device, a friction vibration separator and a dry separation concentrator, the materials feeding device being setup above the friction vibration separator, at least two materials transport grooves being setup below the friction vibration separator, at least two materials transport devices being setup above the dry separation concentrator.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

This invention relates to a method of dry separation for concentration and separation and a system used for the method of dry separation for concentration and separation, pertaining to the technical field of gravity separation.

2. Description of Related Art Including Information Disclosed Under 37 CFR 1.97 and 37 CFR 1.98.

In mining industrial production, objective minerals are usually wrapped by rocks or exist in the soil. Generally, minerals are exposed to the extent over 90% through crushing and grinding, being separated and concentrated by chemicals used in water, making use of the relationship between the objective and different chemicals (with exceptions like iron ore), until the content of minerals reaches some degree of concentration before they are to be smelted.

Vibrating fluidized beds and wash boxes are usually employed at the moment. Among others, for vibrating fluidized beds, people's research primarily focuses on uniformity and drying issues of fine grain particles fluidization, although it is claimed that particles with large density would sink to the bottom; however, it is far from meeting industrialization requirements if this phenomenon is limited only in being pointed out.

Though wash boxes have been applied by human beings for more than one hundred years, its working principle remains unresolved. Water is necessary as medium and manual drive control to the medium is needed. The least diameter of the recoverable heavy mineral particle is 0.02 mm, and only small mineral particles can be detected in recovered minerals without indicating the recovery rate of small mineral particles. Generally speaking, it is not suitable to operate in status where all particles are small particles. Moreover, much ore is required to be crushed to a small size to reach a 90% exposed state in order to be separated.

Thus, inventing a dry separation system without chemicals and which is capable of separating without water as medium has become a development tendency for mineral separation.

### SUMMARY OF THE INVENTION

To counter the drawbacks of the prior art, a method of dry separation for concentration and separation, utilizing air as medium, to dry separate ore and a system used for the method of dry separation for concentration and separation are provided in this invention, in order to accomplish the purposes of separating simply, decreasing production cost, separating without water or any chemicals, and being able to exploit mines where production cannot be carried on due to lack of water source and to exploit resources whose priming cost is high.

The technical solution to overcome the technical problems in this invention is as follows: a method of dry separation for concentration and separation, in which ore is crushed by a crusher first, and after being dry ground, materials are concentrated in conditions of airflow ventilation and vibration of the directional second vibrator by way of a dry separation concentrator, materials being separated by turbulence flow field formed by said dry separation concentrator by means of perforated boards, the included angle between the said perforated boards and the horizontal direction being 2˜20°, the thickness of the said materials being ≦40 MM.

The beneficial effect of the method in this invention is: separation can be done without using chemicals, water being not necessary as medium, minerals can be concentrated and separated in conditions of using air as medium only, the process being simple, being pollution free, cost being saved, mineral resources being able to be exploited partly in areas that lack of water or have difficulty in priming water, and useful substance contained in obsolescing tailings during production may also be recovered and reused.

On the basis of the technical solution mentioned above, improvements as follows may also be made to this invention.

Further, uniformly distributed micro-pores are setup on the said perforated boards, the spacing between the said micro-pores being 50-500 μm, which is less than 1.2 times of the particle diameter of the largest particles group in materials used for separation, the pore diameter of the said micro-pores being less than ⅓ of the spacing. Further, there exists, between the said grinding step and the materials concentration step by means of a dry separation concentrator, a granularity classification step in which materials are roughly separated in conditions of vibration of the directional first vibrator by a friction vibration separator.

The beneficial effect of employing the solution mentioned above is that a lot of fine powders whose diameter is less than 0.1 MM are unavoidably produced during the materials are crushed and dry ground, and it is inefficient and cost much if a screen is used to separate them. Good separation effect may be achieved when materials are separated by friction vibration first for their rough separation, and fine powders and fine particles therein are separated and concentrated, respectively.

Further, the said second vibrator and the horizontal direction forms an angle of 20˜60°, the said first vibrator and the horizontal plane forming an angle of 25˜60°.

Further, materials are roughly separated for particles classification by a friction vibration separator by way of spot blanking, and the materials with different particles classifications after the rough separation are fed into different dry separation concentrators, respectively, for concentration by way of line blanking, the distance between the drop points of the said roughly separated materials and either the concentrated materials or the materials layer are both <20 mm.

Further, the said airflow flows at 0.2˜20 cm³/s; the vibration frequency of the said first vibrator being 20˜30 HZ, with the amplitude of vibration 2-10 mm; the vibration frequency of the said second vibrator being 22-33 HZ, with the amplitude of vibration 0.3-3 mm. The beneficial effect of employing the solution mentioned above is that the light and heavy materials are separated, producing directly desired results.

Another technical solution to solve the technical problems mentioned above in this invention is as follows: a system used for the method of dry separation for concentration and separation comprises a materials feeding device, a friction vibration separator and a dry separation concentrator, the said materials feeding device being setup above the friction vibration separator, at least two materials transport grooves being setup below the said friction vibration separator, materials transport devices that are connected with at least two materials transport grooves being setup above the said dry separation concentrator. The beneficial effect of the system in this invention is: materials can be separated in conditions of using air as medium by way of a friction separator and a dry separation concentrator, the method being simple, the cost being low, the water resource being saved, and there is fundamentally no pollution after dust collection.

Further, the said friction vibration separator comprises the first vibration platform that is setup on the first vibrator, the said first vibration platform and vibration agitation force direction forming an angle of 25˜60°, at least one separation board that forms an angle of 20-50° with the first vibration platform being setup on the said first vibration platform, the said at least one separation board and the vertical direction of the vibration agitation force direction forming an angle of 0˜8°, the said at least one separation board being setup on the at least two materials transport grooves, the said materials feeding device being setup on the top right of the at least one separation board.

The beneficial effect of employing the technical solution mentioned above is that minerals can be separated according to its different granularity by applying vibration friction force through the platform and the separation board that are setup to form a tilted angle with the agitation force.

Further, the separated materials are guided into at least two materials transport grooves by the said at least one separation board through a guide plate.

Further, the said dry separation concentrator comprises the second vibration platform that is setup on the directional second vibrator, the said second vibration platform and the agitation force direction forming an angle of 20˜60°, at least one groove being setup on the said second vibration platform, the said groove being setup below a materials feeding inlet, a perforated board that forms an angle of 2˜20° with the second vibration platform being setup in the said at least one groove, an airtight air chamber being setup below the said perforated board, an air hole, at least one deposits outlet and at least one extravasations outlet of the said groove being setup on the side wall of the said at least one groove, the first orifice plate, the second orifice plate, the third orifice plate and the fourth orifice plate being setup on the periphery of the side walls of the said groove, the said deposits outlet being setup on one side of the lower end of the perforated board on the side wall of the groove, the said extravasations outlet being setup on one side of the higher end of the perforated board on the side wall of the groove.

The beneficial effect of employing the technical solution mentioned above is that minerals can be concentrated and separated according to its different density by way of the vibration platform and the perforated board that are setup to form a tilted angle with the agitation force, lighter materials being separated continuously by the extravasations outlet settings in an overflow way, achieving good separation effect.

Further, materials transport grooves that are setup with respect to the at least one deposits outlet and the at least one extravasations outlet are setup below the said at least one deposits outlet and the at least one extravasations outlet, deposits and extravasations being both guided through the a guide plate by the said at least one deposits outlet and the at least one extravasations outlet into the transport grooves that are setup with respect to the deposits outlet and the extravasations outlet.

Further, a deposits outlet is setup on the said at least one groove, a controllable opening and closing port device being setup on one side wall, the said first orifice plate being setup on one side of the higher end of the perforated board, which is 0.5˜10 mm higher than the higher end of the perforated board, the said second orifice plate, the third orifice plate and the fourth orifice plate being 20 mm higher than the higher end of the perforated board.

The beneficial effect of employing the technical solution mentioned above is that deposited heavy materials are easily let out through the controllable opening and closing device, the settings that other three orifice plates are lower than the orifice plate at the higher end of the perforated board being capable of preventing the heavy materials from being carried out by light materials and at the same time providing an outlet for the light materials to overflow.

Further, the number of the said at least one deposits outlet can be two, which corresponds to the two strokes, the upward stroke and the downward stroke, of the controllable opening and closing device.

The beneficial effect of employing the technical solution mentioned above is that heavier and very much heavier materials can be separated out according to different density.

Further, the said first vibrator and the second vibrator are both fixed on a bracket through a helical spring.

The beneficial effect of employing the technical solution mentioned above is that the purpose of directional vibration is achieved, which is required for the separation of the particles granularity and the output of materials, and is also beneficial for the separation according to density.

### BRIEF DESCRIPTION OF THE DRAWINGS

FIG. 1 is a schematic view showing contrast results of the deposits and extravasations concentrated and separated from iron ore with diameter 0.1-0.06 MM by means of the method of dry separation for concentration and separation illustrated in Embodiment 1 of the invention, 1 indicating deposits and 2 indicating extravasations in the drawing.

FIG. 2 is a schematic view showing contrast results of the deposits and extravasations concentrated and separated from iron ore with diameter 0.25-0.1 MM by means of the method of dry separation for concentration and separation illustrated in Embodiment 1 of the invention, 1 indicating deposits and 2 indicating extravasations in the drawing.

FIG. 3 is a schematic view showing contrast results of the deposits and extravasations separated from iron ore with diameter 0.45-0.2 MM by means of the method of dry separation for concentration and separation illustrated in Embodiment 1 of the invention, 1 indicating deposits and 2 indicating extravasations in the drawing.

FIG. 4 is a schematic view showing contrast results of the deposits and extravasations separated from ilmenite by means of the method of dry separation for concentration and separation illustrated in Embodiment 2 of the invention, 1 indicating deposits and 2 indicating extravasations in the drawing.

FIG. 5 is a schematic view showing the structure of the friction vibration separator of the system used for the method of dry separation for concentration and separation illustrated in Embodiment 1 of the invention.

FIG. 6 is a schematic view showing the structure of the dry separation concentrator of the system used for the method of dry separation for concentration and separation illustrated in Embodiment 1 of the invention.

FIG. 7 is a schematic view showing the structure of the dry separation concentrator of the system used for the method of dry separation for concentration and separation illustrated in Embodiment 2 of the invention.

### DETAILED DESCRIPTION OF THE DRAWINGS

When principles and features of this invention will be described below with reference to drawings. The examples cited are used only for explaining the invention but not for limiting the scope of this invention.

### Embodiment 1

Preliminary Screening of Ore

Iron ore is crushed by a crusher first, and after being dry ground, materials are roughly separated for particles classification by a friction vibration separator in conditions of vibration of the directional first vibrator by way of spot blanking. Particles of iron ore with diameter 0.45-0.06 MM are separated into iron ore with diameter 0.1-0.06 MM, iron ore with diameter 0.25-0.1 MM and iron ore with diameter 0.45-0.2 MM according to the diameter of the particles. The vibration frequency of the said first vibrator is 21 HZ, with the amplitude of vibration 6 mm.

Concentration of the Ore after Rough Separation

The three groups of iron ore separated above are transported to the dry separation concentrator illustrated in Embodiment 1, respectively, and are concentrated in conditions of different airflow ventilation and vibration of the directional second vibrator by way of line blanking, the vibration frequency of the said second vibrator being 30 HZ, with the amplitude of vibration 0.3-3 mm. Uniformly distributed micro-pores are set on the said perforated boards, the pore diameter of the said micro-pores being less than 30 μm, the particle diameter of the said materials <450 μm, the spacing between the said perforated boards used for separating materials ≦100 μm, the thickness of the materials used for separation on the said perforated boards 40 MM. The said iron ore with diameter 0.1-0.06 MM, iron ore with diameter 0.25-0.1 MM and iron ore with diameter 0.45-0.2 MM are separated by way of different airflows flowing within 1-6 cm³/s.

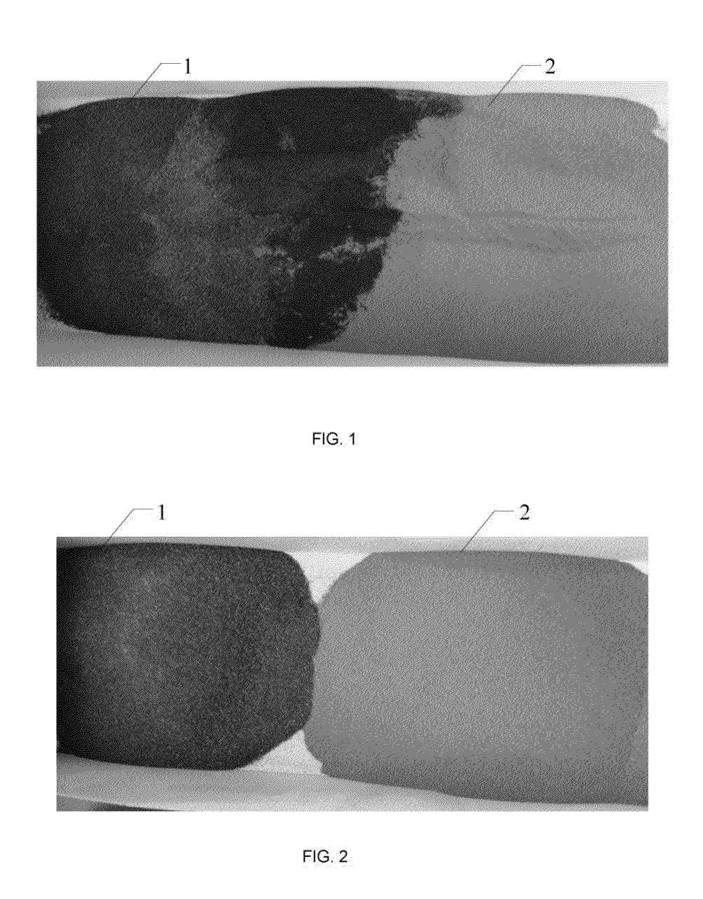

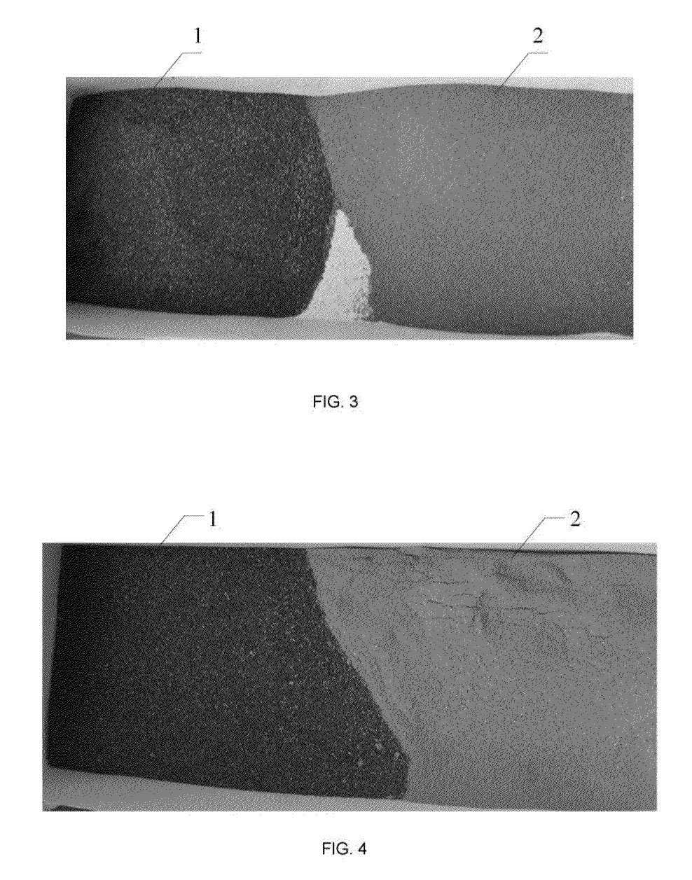

FIG. 1 is a schematic view showing contrast results of the deposits and extravasations after the separation of the iron ore with particle diameter 0.1-0.06 MM. As can be seen from the figure, the separation effect meets the industrial production requirements, the recovery rate being larger than 92% by way of simple measurement using magnets. FIG. 2 is a schematic view showing contrast results of the deposits and extravasations after the separation of the iron ore with particle diameter 0.25-0.1 MM. As can be seen from the figure, the separation effect meets the industrial production requirements, the recovery rate being larger than 94% by way of simple measurement using magnets. FIG. 3 is a schematic view showing contrast results of the deposits 1 and extravasations 2 after the separation of the iron ore with particle diameter 0.45-0.2 MM. As can be seen from the figure, the recovery rate is quite high; however, some amount of sands is entrapped in the finished products (The reasons have been identified until now).

Therefore, the separation effect of the method in the invention is remarkable and meets the industrial requirements, the recovery rate being larger than 92% except for the smallest particles (with diameter less than 0.06 MM).

### Embodiment 2

The ilmenite, which locates in Dali, Yunnan Province, is the ilmenite with the content being 18% and meshes being 60. The percentage that ore particles with diameter under 0.1 MM have in the ore are less than one percent, thus simplified process is employed. After the soil being stripped by a sand maker, the ilmenite is fed directly into the concentrator, which is directly the dry separation concentrator illustrated in Embodiment 2, and concentrated in conditions of airflow ventilation and vibration of the directional second vibrator by way of line blanking, the said vibration frequency of the second vibrator being 30 HZ, with the amplitude of vibration 0.3˜3 mm. Uniformly distributed micro-pores are set on the said perforated boards, the spacing between the said micro-pores <100 μm, the pore diameter of the said micro-pores being less than 30 μm.

FIG. 4 is a schematic view showing contrast results of the deposits and extravasations after the separation of the ilmenite. As can be seen from the figure, the separation effect is quite good, whose recovery rate reaches as high as 98% or above.

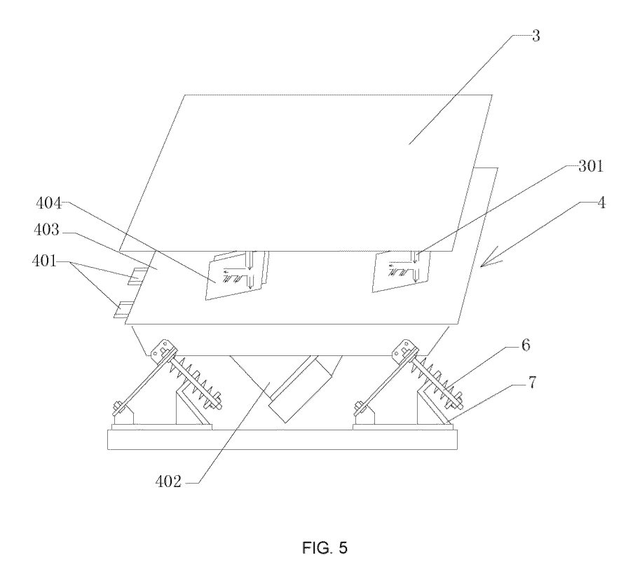

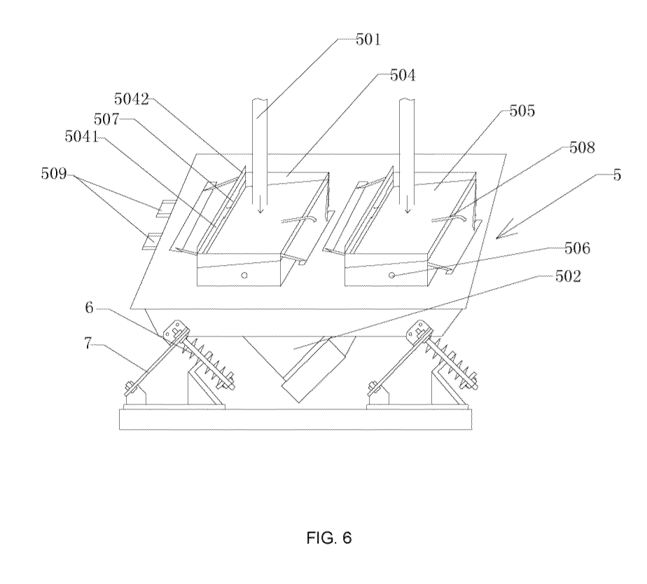

As can be seen from FIGS. 5-6, the system used for the method of dry separation for concentration and separation illustrated in Embodiment 1 of the invention comprises a materials feeding device 3, a friction vibration separator 4 and a dry separation concentrator 5, the said materials feeding device 3 being setup above the friction vibration separator 4, at least two materials transport grooves 401 being setup below the said friction vibration separator 4, materials transport devices that are connected with at least two materials transport grooves being setup above the said dry separation concentrator 5, two materials feeding inlets 501 being connected with the said materials transport devices.

The said friction vibration separator 4 comprises the first vibration platform 403 that is setup on the first vibrator 402, the said first vibration platform 403 and agitation force direction forming an angle of 25˜60°, at least one separation board 404 that forms an angle of 20-50° with the first vibration platform 403 being setup on the said first vibration platform 403, the said at least one separation board 404 and the vertical direction of the vibration agitation force forming an angle of 0˜8°, the said at least separation board 404 being setup above the at least two materials transport grooves 401, the separated materials being guided into the at least two materials transport grooves 401 by the said at least one separation board 404 through a guide plate, the distance between the opening for materials to fall in 301 of the said materials feeding device 3 and the top right of the at least one separation board 404 being 5˜8 mm. The said dry separation concentrator 5 comprises the second vibration platform 503 that is setup on the second vibrator 502, the said second vibration platform 503 and the agitation force direction forming an angle of 40°, at least one groove 504 being setup on the said second vibration platform 503, the said groove 504 being setup below the materials feeding inlet 501, the said materials being separated according to its different density by the action of tilted turbulence flow field. A perforated board 505, which forms an angle of 5° with the second vibration platform 503, is setup in the said at least one groove 504, material with good vibration conductivity being employed by the said perforated board 505, the spacing between turbulence flow groups with high quality distributing uniformly, the spacing between the said perforated board being less than or equal to 1.2 times of the particle diameter of the largest deposited high density particles group in the objective particles to be separated, the width of the said perforated board 505 being 60˜400 mm, an airtight air chamber being setup below the perforated board 505 in the said groove. An air hole 506, a deposits outlet 507 and an overflow port 508 are setup on the side wall of the said groove 504, the said deposits outlet 507 being setup on the side wall at one lower end side of the perforated board of the groove, the said overflow port 508 being setup on one side of the higher end of the perforated board of the groove, the first orifice plate, the second orifice plate, the third orifice plate and the fourth orifice plate being setup on the periphery of the side walls of the said groove 504, a controllable opening and closing port device 5041 being setup on the side wall at one lower end side of the said perforated board 505 as well, the said first orifice plate 508 (it is both the higher end orifice plate of the perforated board and the extravasations outlet) being setup on the side wall at one higher end side of the perforated board 505, the orifice plate 508 being 0.5-10 mm higher than the higher end of the perforated board, and this orifice plate being lower than orifice plates on other side walls, the orifice plates on other side walls, i.e. the second orifice plate, the third orifice plate and the fourth orifice plate, being 20 mm higher or more than the perforated board, the thickness of the largest thickness end of the materials on the perforated board in the said groove 504 being no more than 40 mm, the thickness of the thinnest materials thickness end being 0.5-10 MM, the distance between the said materials feeding inlet 501 and the side wall of the lower end of the perforated board of the groove being 20˜40 mm, materials transport grooves 509 being setup below the said deposits outlet 507 and the extravasations outlet 508 that are setup with respect to the deposits outlet 507 and the extravasations outlet 508, deposits and extravasations being both guided through the a guide plate by the said deposits outlet 507 and the extravasations outlet 508 into the transport grooves 509 that are setup with respect to the deposits outlet 507 and the extravasations outlet 508, the said first vibrator 402 and the second vibrator 502 being both fixed on the bracket 7 through the helical spring 6.

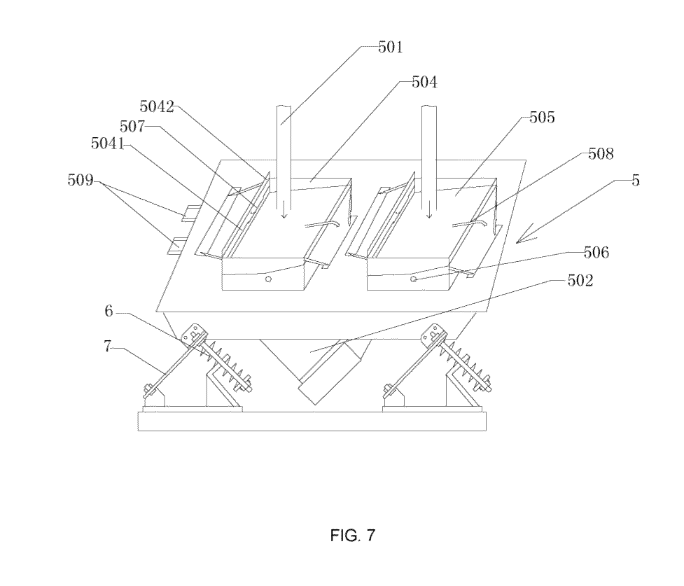

As can be seen from FIG. 7, the differences between the dry separation concentrator of the system used for the method of dry separation for concentration and separation illustrated by Embodiment 2 of the invention and that illustrated by Embodiment 1 are that the perforated board 505 is slightly curved, being capable of increasing the volume of the deposits at the bottom, the controllable opening and closing port device of the materials outlet being divided into two parts, the upper part and the lower part, being capable of controlling opening and closing state, respectively. It is designed for deposits with two different densities, being suitable for use when the content of one extremely heavy deposit is very low.

Another embodiment that is different from Embodiment 1 which is shown in FIG. 6 is that every two grooves 504 are set as one group, the height of one of the grooves 504 being increased, making the extravasations outlet be directed at the materials feeding position of another groove 504 through a guide plate, with the purposes to make the extravasations of the first groove enter into the second groove and be concentrated again in conditions of decreasing the airflow amount, with the advantages of increasing the range of concentrated particles and the recovery rate.

The above are just preferred embodiments of this invention, but are not for limiting this invention. Any modifications, equivalents, improvements, etc. that are made within the spirit and the scope of this invention should all be included in the claimed scope of this invention.

1. A method of dry separation for concentration and separation, the method comprising the steps of:
crushing ore is by a crusher first, and
after being dry ground, concentrating materials in conditions of airflow ventilation and vibration of the directional second vibrator by way of a dry separation concentrator, materials being separated by turbulence flow field formed by said dry separation concentrator by perforated boards, the included angle between said perforated boards and the horizontal direction being 2˜20°, the thickness of said materials being 40 MM.

2. The method of dry separation for concentration and separation of claim 1, wherein uniformly distributed micro-pores are setup on said perforated boards, the spacing between said micro-pores being 50-500 μm, which is less than 1.2 times of the particle diameter of the materials used for separation, pore diameter of said micro-pores being less than ⅓ of the spacing.

3. The method of dry separation for concentration and separation of claim 1, further comprising the step of:
Classifying granularity between the grinding step and the materials concentration step, wherein materials are roughly separated in conditions of vibration of the directional first vibrator by a friction vibration separator.

4. The method of dry separation for concentration and separation of claim 1, wherein said second vibrator and the horizontal direction forms an angle of 20˜60°, the said first vibrator and the horizontal plane forming an angle of 25˜60°.

5. The method of dry separation for concentration and separation of claim 1, wherein materials are roughly separated for particles classification by a friction vibration separator by way of spot blanking, and wherein the materials with different particles classifications after the rough separation are fed into different dry separation concentrators, respectively, for concentration by way of line blanking, the distance between the drop points of the said roughly separated materials and either the concentrated materials or the materials layer are both <20 mm.

6. The method of dry separation for concentration and separation of claim 1, wherein said airflow flows at 0.2˜20 cm³/s; the vibration frequency of the said first vibrator being 20˜30 HZ, with the amplitude of vibration 2-10 mm; the vibration frequency of the said second vibrator being 22˜33 HZ, with the amplitude of vibration 0.3-3 mm.

7. A system used for the method of dry separation for concentration and separation of claim 1, the system comprising:
a materials feeding device,
a friction vibration separator and
a dry separation concentrator, said materials feeding device being setup above the friction vibration separator, at least two materials transport grooves being setup below said friction vibration separator, materials transport devices being setup above said dry separation concentrator.

8. The system used for the method of dry separation for concentration and separation of claim 7, the wherein said friction vibration separator comprises the first vibration platform that is setup on the first vibrator, said first vibration platform and vibration agitation force direction forming an angle of 25˜60°, at least one separation board that forms an angle of 20-50° with the first vibration platform being setup on said first vibration platform, said at least one separation board and the vertical direction of the vibration agitation force direction forming an angle of 0˜8°, said at least one separation board being setup on the at least two materials transport grooves, said materials feeding device being setup on the top right of the at least one separation board.

9. The system used for the method of dry separation for concentration and separation of claim 7, the wherein said dry separation concentrator comprises the second vibration platform that is setup on the directional second vibrator, said second vibration platform and the agitation force direction forming an angle of 20˜60°, at least one groove being setup on said second vibration platform, said groove being setup below a materials feeding inlet, a perforated board that forms an angle of 2˜20° with the second vibration platform being setup in said at least one groove, an airtight air chamber being setup below said perforated board, an air hole, at least one deposits outlet and at least one extravasations outlet of said groove being setup on the side wall of said at least one groove, the first orifice plate, the second orifice plate, the third orifice plate and the fourth orifice plate being setup on the periphery of the side walls of the said groove, said deposits outlet being setup on one side of the lower end of the perforated board on the side wall of the groove, said extravasations outlet being setup on one side of the higher end of the perforated board on the side wall of the groove.

10. The system used for the method of dry separation for concentration and separation according to claim 8, further comprising:
a deposits outlet setup on said at least one groove, a controllable opening and closing port device being setup on one side wall, the said first orifice plate being setup on one side of the higher end of the perforated board, which is 0.5˜10 mm higher than the higher end of the perforated board, said second orifice plate, the third orifice plate and the fourth orifice plate being 20 mm or more higher than the higher end of the perforated board.
